(19) United States
(12) Patent Application Publication
(10) Pub. No.: US 2015/0153744 A1
(43) Pub. Date: Jun. 4, 2015

(54) CONTROLLER FOR A FLUID DISTRIBUTION SYSTEM AND METHOD OF OPERATION THEREOF

(71) Applicant: Ultraflo Systems, LLC, Toledo, OH (US)

(72) Inventors: JOSHUA D. DIDION, Toledo, OH (US); Jeffrey L. Pickle, Loveland, OH (US)

(21) Appl. No.: 14/559,964

(22) Filed: Dec. 4, 2014

Related U.S. Application Data
(60) Provisional application No. 61/911,540, filed on Dec. 4, 2013.

(51) Int. Cl. G05D 7/06; G05B 15/02

(52) U.S. Cl. CPC G05D 7/0629; G05B 15/02

(57) ABSTRACT

A controller for use with a fluid distribution system and method of operation thereof is provided. The controller comprises a touch screen, a processing unit, and an output interface. The processing unit is in communication with the touch screen. The output interface is in communication with the processing unit and the fluid distribution system. In response to a touch input from a user, the processing unit accesses at least one valve profile and adjusts a state of operation of the fluid distribution system through the output interface.

### RELATED APPLICATIONS

The present application claims the benefit of U.S. Provisional Application No. 61/911,540 filed on Dec. 4, 2013, which is incorporated herein in its entirety by reference.

### FIELD OF THE INVENTION

The invention relates to fluid distribution systems and, more particularly, to a controller for operating a fluid distribution system and a method of operation thereof.

### BACKGROUND OF THE INVENTION

Fluid distribution systems are very common in a variety of environments, such as residential homes, offices, and commercial and industrial buildings. Fluid distribution systems rely on a pressurization of a fluid to deliver the fluid to a point of use. Conventionally, manually operated valves operated at the point of use are used to control delivery of the fluid. However, a fluid distribution system including electrically operated valves which are triggered by a user or an automated system may also be used to control delivery of the fluid. U.S. Pat. No. 2,991,481, “FLUID DISTRIBUTION CONTROL SYSTEM” to Book, filed on Mar. 17, 1958, which is hereby incorporated by reference in its entirety, describes such a fluid distribution system. Such fluid distribution systems have been commonly referred to as “push button plumbing.”

Fluid distribution systems including electrically operated valves offer many benefits over conventional fluid distribution systems including manually operated valves. Such systems require less work for installation and maintenance, may be easily automated, provide greater failsafe operation, and provide for conservation of energy and water.

Mixing of two water temperatures in conventional fluid distribution systems occurs at the point of use. As a result, each point of use must be fitted with two separate water lines. Each of these water lines is run from a water source to the point of use. Fluid distribution systems including electrically operated valves may require only a single water line for a significant portion of a distance between the water sources and the point of use, as the electrically operated valve may be positioned closer to each of the water sources.

Fluid distribution systems including electrically operated valves may be more easily automated than conventional fluid distribution systems. The addition of automation equipment to the conventional fluid distribution system typically requires the replacement of the manually operated valves with electrically operated valves and the installation of electronics for operating the valves. In contrast, fluid distribution systems including electrically operated valves require fewer additional components to enable automation. The electrically operated valves are typically operated with low voltage power systems, and are therefore compatible with many types of electronic automation equipment commercially available.

In environments which use the conventional fluid distribution system, failure of a valve or a pipe may result in significant damage to property, if a fluid within the distribution system is dispersed in the environment without control. Fluid distribution systems including electrically operated valves, however, may be configured so that all of the valves may be positioned in a single location. Such a location may be configured to collect or restrain fluid in the event of a failure of a valve or a pipe, reducing an amount of damage the failure may cause.

Fluid distribution systems including electrically operated valves may provide for conservation of energy and water. Such systems may be configured with valves configured to reduce a fluid flow therethrough. For tasks not requiring a full fluid flow, a user of the system may select a setting having the reduced flow rate, thus conserving water. Additionally, conventional fluid distribution systems may include an extensive amount of pipe for use with hot water. During period of non-operation of the conventional fluid distribution system, the hot water pipes cool to a temperature of an ambient environment. Further, once a request for hot water is received, the hot water pipes may initially absorb a significant amount of heat from the hot water. In conventional fluid distribution systems, this water and any energy associated with its heating, goes to waste. By reducing an amount of hot water pipe used in the fluid distribution system and by providing reduced flow rate settings, the fluid distribution systems including electrically operated valves provides for conservation of energy and water.

Despite the above mentioned benefits, fluid distribution systems including electrically operated valves are not without faults. Controllers employed at a point of use must be easy to operate while not restricting function. Such controllers to date have lacked the simple versatility of manually operated valves. Additionally, such controllers have not taken advantage of technological improvements now available. Such technological improvements may be used to enhance a user experience, such as by providing an enhanced interface, greater control over the electrically operated valves, and allow customization at the point of use by a user.

Previously, interfaces used with fluid distribution systems including electrically operated valves were minimal. In one version, the interface consisted of a plurality of labeled buttons, and operation of the system was performed by pressing one or more of the buttons. In this version, the selected button remained depressed until another selection was made or an “off” button was depressed. In another version, the interface consisted of a plurality of soft buttons and corresponding LED indicators. In this version, upon selection of a button, the corresponding LED indicator would be placed in a lighted state until another selection was made or an “off” button was depressed.

Such interfaces reflected the inherent limitations of the fluid distribution systems including electrically operated valves. At a single point of use, such interfaces were not configured to operate more than five of the electrically operated valves, and only operation of three of those valves could be used to affect fluid temperature. Accordingly, greater control over such a fluid distribution system was limited by such a minimal interface.

Previously, the fluid distribution systems including electrically operated valves allowed for calibration of any given valve of the system to affect the performance of the system. Such calibration could be used to adjust a mixture of hot and cold water to a preference of a user of the system. However, such calibration only applied to the single point of use corresponding to the calibrated set of valves. Further, such calibration required adjustment at the location of the valve, not the location of use. As a result, individual temperature preferences by a plurality of users of the system were impossible to obtain without performing a calibration routine between users.

It would be advantageous to develop a controller for a fluid distribution system and a method of operation thereof that provides an enhanced interface, provides greater control over electrically operated valves of the fluid distribution system, provides for increased conservation of energy and water, and allows customization at the point of use by a user.

### SUMMARY OF THE INVENTION

Presently provided by the invention, a controller for a fluid distribution system and a method of operation thereof that provides an enhanced interface, provides greater control over electrically operated valves of the fluid distribution system, provides for increased conservation of energy and water, and allows customization at the point of use by a user, has surprisingly been discovered.

In one embodiment, the present invention is directed to a controller for use with a fluid distribution system. The controller comprises a touch screen, a processing unit, and an output interface. The processing unit is in communication with the touch screen. The output interface is in communication with the processing unit and the fluid distribution system. In response to a touch input from a user, the processing unit accesses at least one valve profile and adjusts a state of operation of the fluid distribution system through the output interface.

In another embodiment, the present invention is directed to a fluid distribution system. The fluid distribution system comprises a primary plumbing arrangement, a valving arrangement, a secondary plumbing arrangement, a system controller in communication with the valving arrangement, and a controller in communication with the system controller. The primary plumbing arrangement is in fluid communication with a fluid source. The valving arrangement is in fluid communication with the primary plumbing arrangement. The secondary plumbing arrangement is in fluid communication with the valving arrangement. The system controller is in communication with the valving arrangement. The controller is in communication with the system controller. The controller comprises a touch screen, a processing unit in communication with the touch screen, and an output interface in communication with the processing unit and the fluid distribution system. In response to a touch input from a user, the processing unit accesses at least one valve profile and adjusts the valving arrangement of the fluid distribution system through the output interface and the system controller.

In yet another embodiment, the present invention is directed to a method of operating a fluid distribution system. The method comprises the steps of providing the fluid distribution system in fluid communication with a fluid source, providing a controller in communication with the fluid distribution system, providing a touch input from a user of the fluid distribution system to the processing unit via the touch screen, accessing at least one valve profile using the processing unit in response to the touch input from a user, and adjusting the valving arrangement of the fluid distribution system using the processing unit through the output interface. The fluid distribution system includes a valving arrangement. The controller comprises a touch screen, a processing unit in communication with the touch screen, and an output interface in communication with the processing unit and the fluid distribution system.

Various aspects of this invention will become apparent to those skilled in the art from the following detailed description of the preferred embodiment, when read in light of the accompanying drawings.

### BRIEF DESCRIPTION OF THE FIGURES

The above, as well as other advantages of the present invention will become readily apparent to those skilled in the art from the following detailed description when considered in the light of the accompanying drawings in which:

FIG. 1 is an exploded, schematic style illustration of a controller in communication with a fluid distribution system;

FIG. 2 is a schematic illustration of the fluid distribution system and controller illustrated in FIG. 1;

FIG. 3 is a perspective view of a valving arrangement forming a portion of the fluid distribution system illustrated in FIG. 2;

FIG. 4 is a schematic illustration of a portion of the fluid distribution system illustrated in FIG. 2 in communication with a plurality of the controllers illustrated in FIG. 1;

FIG. 5 is a schematic illustration of a portion of the fluid distribution system illustrated in FIG. 2 in communication with the controller illustrated in FIG. 1, the fluid distribution system and the controller configured for use with a shower;

FIG. 6 is a schematic illustration of a portion of the fluid distribution system illustrated in FIG. 2 in communication with the controller illustrated in FIG. 1, the fluid distribution system and the controller configured for use with a lavatory sink;

FIG. 7 is a schematic illustration of a portion of the fluid distribution system illustrated in FIG. 2 in communication with the controller illustrated in FIG. 1, the fluid distribution system and the controller configured for use with a kitchen sink; and

FIG. 8 is a schematic illustration of a portion of the fluid distribution system illustrated in FIG. 2 in communication with the controller illustrated in FIG. 1, the fluid distribution system and the controller configured for use with a recirculation system.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

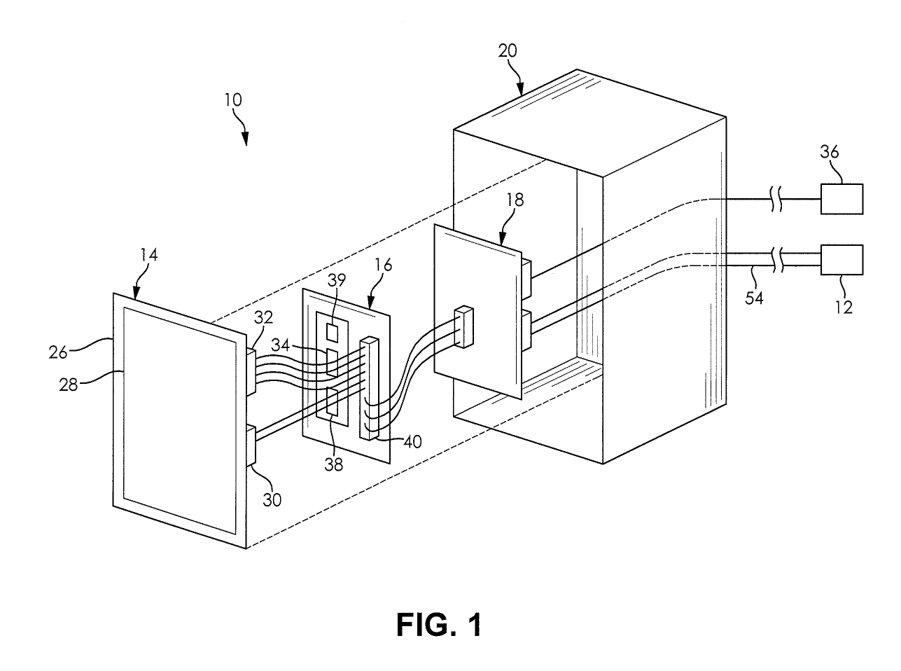

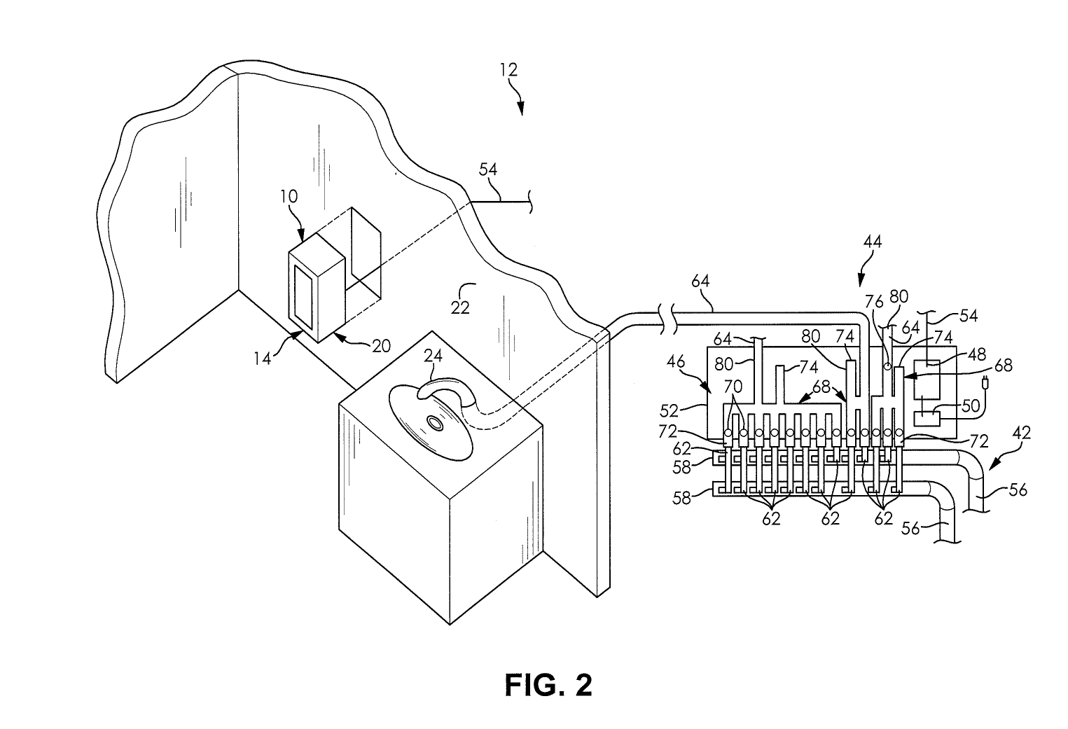

FIG. 1 illustrates a controller 10 for a fluid distribution system 12 (more clearly illustrated in FIG. 2) according to an embodiment of the invention. The controller 10 comprises a touch screen 14, a processing unit 16, and an output interface 18. The touch screen 14, the processing unit 16, and the output interface 18 are disposed within a controller housing 20. The controller housing 20 including the controller 10 are typically disposed in a wall 22 (shown in FIG. 2) adjacent a plumbing outlet 24 (also shown in FIG. 2); however, it is understood that the controller 10 may be disposed in a stand-alone housing adjacent the plumbing outlet 24, may be mounted in a countertop or a vanity top, or may be mounted in another manner adjacent the plumbing outlet 24. The controller 10 is in electrical communication with the fluid distribution system 12 to supply a fluid to the plumbing outlet 24 using the fluid distribution system 12.

The touch screen 14 is a display device capable of providing output data based on a touch input by a user of the controller 10. The touch screen 14 comprises a display 26, a touch detection unit 28, an input 30, and an output 32. The touchscreen 14 is in electrical and data communication with the processing unit 16 via the input 30 and the output 32.

The display 26 in an LCD unit capable of displaying graphical content stored and/or generated by the processing unit 16; however, it is understood that other display technologies, such as LED or OLED, among others, may be used. The display 26 is in data communication with the processing unit 16 via the input 30. The display 26 is powered via an electrical connection (not shown) with the processing unit 16; however, it is understood that the display 26 may be powered separate from the processing unit 16 or that the electrical connection may form a portion of the input 30.

The touch detection unit 28 is a device capable of generating an output signal in response to a touch input by the user of the controller 10. The touch detection unit 28 may be a resistive or capacitive panel; however, it is understood that other touch detection technologies may be used. The touch detection unit 28 is in data communication with the processing unit 16 via the output 32. It is understood that the touch detection unit 28 and the display 26 of the touch screen 14 may form an integrated unit or that the touch detection unit 28 and the display 26 may be separate components. The touch detection unit 28 is powered via an electrical connection (not shown) with the processing unit 16; however, it is understood that the touch detection unit 28 may be powered separate from the processing unit 16 or that the electrical connection may form a portion of the input 30 or the output 32.

The input 30 is a portion of the touch screen 14 which receives a video signal from the processing unit 16. The input 30 may include specialized circuitry which facilitates conversion of the video signal into a format compatible with the display 26.

The output 32 is a portion of the touch screen 14 which transmits a data signal from the touch detection unit 28 to the processing unit 16. The output 32 may include specialized circuitry which facilitates conversion of the data signal into a format compatible with the processing unit 16.

The processing unit 16 is a computing device forming a portion of the controller 10. At least one microprocessor 34 of the processing unit 16 executes a series of instructions in response to the data signal from the output 32 of the touch screen 14. The at least one microprocessor 34 may also execute a series of instructions in response to a data signal from a sensor 36 via the output interface 18. In response to the signal from the touch screen 14, the processing unit 16 may access information on a storage device 38 forming a portion of the processing unit 16, change information on the storage device 38, adjust a signal supplied to the output interface 18, and adjust a signal supplied to the input 30. It is understood that the series of instructions executed by the at least one microprocessor 34 may be stored on the storage device 38 or an additional storage device (not shown). The processing unit 16 comprises a printed circuit board onto which the at least one microprocessor 34, the storage device 38, a communication module 39, and other components are mounted to. The processing unit 16 may comprise at least one microcontroller which includes the microprocessor 34, the storage device 38, and the communication module 39. However, it is understood that the communication module 39 may be separate from and in communication with the microcontroller. The at least one microcontroller includes data storage capability in the form of random access memory (RAM). The random access memory is used to facilitate operation of the processing unit 16 through the temporary storage of data, such as operating instructions that allow the processing unit 16 to access information on a storage device 38 forming a portion of the processing unit 16, change information on the storage device 38, facilitate communication using the communication module 39, adjust a signal supplied to the output interface 18, and adjust a signal supplied to the input 30. The processing unit 16 includes a plurality of inputs and outputs 40, and at least a portion of the plurality of inputs and outputs 40 are in communication with the input 30 and the output 32 of the touch screen 14. As a non-limiting example, the processing unit 16 may be in communication with the touch screen 14 through a serial interface using the RS-232 standard. Another portion of the plurality of inputs and outputs 40 are in communication with the output interface 18. As a non-limiting example, the processing unit 16 may be in communication with the output interface 18 through a plurality of digital outputs. As another non-limiting example, the communication module 39 may be a Wi-Fi™ compliant module.

The storage device 38 is in communication with the at least one microprocessor 34. The storage device 38 may be an EEPROM chip, a flash memory chip, or another form of non-volatile computer memory. As mentioned hereinabove, the microprocessor 34 may access information on the storage device 38 or change information on the storage device 38. Information stored on the storage device 38 may include at least one temperature profile, a series of instructions to be executed by the processing unit 16, or a series of instructions used to operate the at least a portion of the touch screen 14.

The output interface 18 facilitates communication between the processing unit 16 and the fluid distribution system 12. Further, as mentioned hereinabove, the output interface 18 may also facilitate communication between the sensor 36 and the processing unit 16. The output interface 18 includes specialized circuitry which facilitates conversion of a microcontroller level output signal from a portion of the plurality of inputs and outputs 40 to an output level compatible with the fluid distribution system 12.

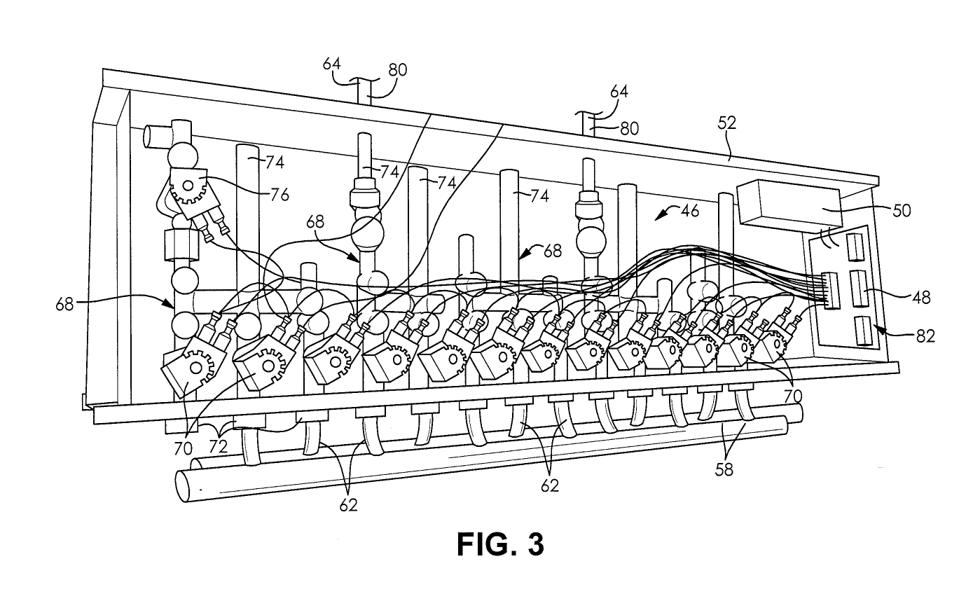

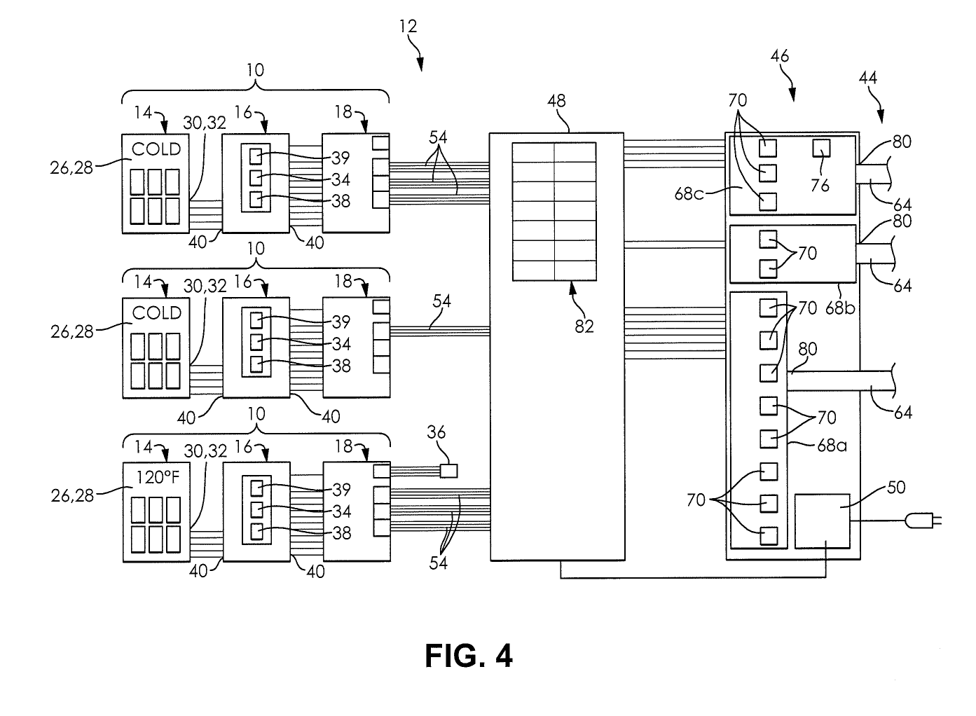

The fluid distribution system 12 comprises a primary plumbing arrangement 42, a secondary plumbing arrangement 44, a valving arrangement 46, a system controller 48, and a power supply 50. The fluid distribution system 12 is illustrated in FIG. 2. A portion of the fluid distribution system is illustrated in FIGS. 3 and 4. FIG. 4 schematically illustrates a portion of the fluid distribution system 12 in communication with a plurality of the controllers 10. At least a portion of the secondary plumbing arrangement 44, the valving arrangement 46, the system controller 48, and the power supply 50 are disposed in an enclosure 52; however, it is understood that a portion of the valving arrangement 46, the system controller 48, and the power supply 50 may be disposed in a plurality of enclosures 52. The system controller 48 of the fluid distribution system 12 is in electrical communication with the output interface 18 of the controller 10 via a communication line 54.

The primary plumbing arrangement 42 comprises a pair of conduits 56 and a pair of inlet manifolds 58. Each of the pair of conduits 56 comprises conventional plumbing components (such as pipes and elbows) and is in fluid communication with a fluid source. The fluid source may be a water main, a pump, or a reservoir, for example. One of the conduits 56 is in fluid communication with a water heater to supply a heated fluid to one of the inlet manifolds 58. It is understood that the fluid distribution system 12 may also be supplied with filtered water or softened water via the pair of conduits 56 in any conventional manner. Each of the inlet manifolds 58 is a conduit having a plurality of branch conduits 62 extending therefrom, each of the plurality of branch conduits 62 in fluid communication with a portion of the valving arrangement 46. It is understood that the branch conduits 62 may be configured to supply a mixture of water from each of the conduits 56 to a portion of the valving arrangement 46, such as through a tee fitting.

The secondary plumbing arrangement 44 comprises a plurality of conduits 64. Each of the plurality of conduits 64 comprises conventional plumbing components (such as pipes and elbows) and is in fluid communication with a portion of the valving arrangement 46, as will be described hereinbelow. Each of the plurality of conduits 64 facilitates fluid communication between a portion of the valving arrangement 46 and one of a plurality of fluid use locations. As non-limiting examples, the fluid use locations may be a kitchen sink, a lavatory sink, or a shower. It is understood that the plurality of fluid use locations may comprise any other location which may be supplied with hot water, cold water, or a mixture of hot and cold water.

The valving arrangement 46 comprises a plurality of valving manifolds 68, each having at least two solenoid valves 70 disposed therein. The valving manifolds 68 illustrated in FIG. 3 include two or three solenoid valves 70 disposed adjacent corresponding inlets 72 of the valving manifold 68. Each of the inlets 72 is in fluid communication with at least one of the conduits 56 through the branch conduits 62. It is understood that the valving manifolds 68 may be configured with any number of inlets 72 and solenoid valves 70, such as illustrated in FIG. 2, where the valving manifolds 68 respectively include two, three, and eight solenoid valves 70. Each of the valving manifolds 68 also includes at least one hammer arrestor 74. As shown in FIGS. 2 and 3, one of the valving manifolds 68 may include a restricting solenoid valve 76 disposed adjacent an outlet 80 of the valving manifold 68; however, it is understood that any number of the valving manifolds 68 may include the restricting solenoid valve 76. While not illustrated in FIG. 2 or 3, it is understood that a plurality of the outlets 80 of the valving manifolds 68 may be in fluid communication to act as a valving manifold having a greater number of inlets 72 and solenoid valves 70.

Each of the solenoid valves 70 may be placed in an open position and a closed position. In the closed position, the solenoid valve 70 does not permit fluid to flow from the corresponding inlet 72 to the associated outlet 80 through the valving manifold 68. In the open position, the solenoid valve 70 permits fluid to flow from the corresponding inlet 72 to the associated outlet 80 through the valving manifold 68. Each of the solenoid valves 70 may be adjusted to change a flow rate therethrough when placed in the open position.

Each of the restricting solenoid valves 76 may be placed in an open position and a restricted position. In the open position, the restricting solenoid valve 76 permits fluid to flow from the valving manifold 68 to the associated outlet 80 in a generally unrestricted manner. In the restricted position, the restricting solenoid valve 76 permits fluid to flow from the valving manifold 68 to the associated outlet 80 at flow rate less than a flow rate when the restricting solenoid valve 76 is placed in the open position. Each of the restricting solenoid valves 76 may be adjusted to change a flow rate therethrough when placed in the restricted position.

The system controller 48 actuates the solenoid valves 70 and the restricting solenoid valves 76 in response to signals received from the controller 10. The system controller 48 includes a plurality of relay circuits 82. Each of the relay circuits 82 corresponds to one of the solenoid valves 70 and the restricting solenoid valves 76. In response to signals the system controller 48 receives from the output interface 18, which are generated by the output interface 18 of the controller 10.

The system controller 48 communicates with and supplies power to the controller 10 via the communication line 54. The communication line 54 is a multi-conductor cable having registered jack connectors attached thereto; however, it is understood that the communication line 54 may comprise any type of conductor. It is understood that the output interface 18 and the system controller 48 each include an interface corresponding to the communication line 54.

The power supply 50 supplies a low voltage current to the system controller 48 for operation of the solenoid valves 70, the restricting solenoid valves 76, and the controller 10. The power supply 50 converts alternating current to direct current and also transforms alternating current from one voltage to another. The power supply 50 supplies about 12 volts of direct current electric potential and about 12 volts of alternating electric current potential; however, it is understood that the controller 10 and the fluid distribution system 12 may be configured for other voltages. As a non-limiting example, the controller 10 may be powered using direct current potential and the plurality of solenoid valves 70 may be powered using alternating current potential.

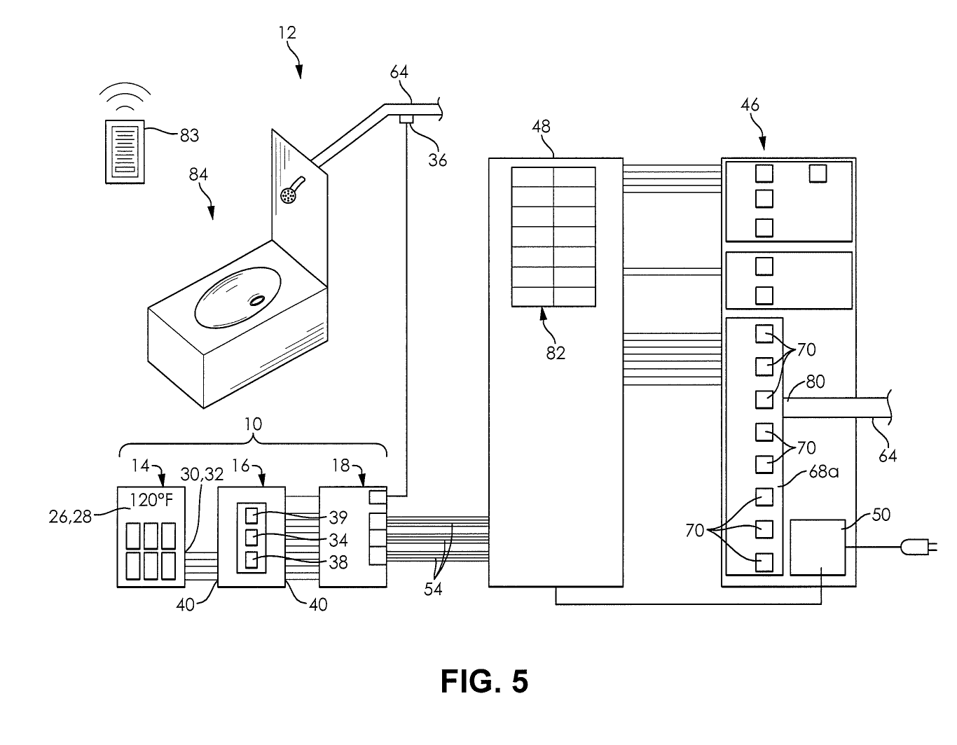

In use, the controller 10 and the fluid distribution system 12 may be configured in a plurality of arrangements based on the fluid use locations 66. As non-limiting examples, the controller 10 and the fluid distribution system 12 may be configured for supplying water to a kitchen sink, a lavatory sink, or a shower; however, it is understood that the controller 10 and the fluid distribution system 12 may be configured for other fluid use locations such as a utility sink or a bath tub, for example. The controller 10 and the fluid distribution system 12 may also be configured to be controlled using a wireless communication device 83 (shown in FIGS. 5-8) over a local area wireless network, which may be a Wi-Fi™ wireless network.

The communication device 83 may be used as a user interface for at least one controller 10 using at least one specialized application installed on the communication device 83. The communication device 83 may be a mobile phone, a personal media player, a tablet computer, a notebook computer, a personal digital assistant, a handheld gaming device, and an e-book reading device. Further, it is understood that other devices may be used. The communication device 83 may be a Wi-Fi™ compliant device. The communication device 83 is configured to send and receive information from the user to the processing unit 16 over a local area wireless network.

The communication device 83 and the controller 10 may also facilitate the generation of a usage report regarding the operation of the fluid distribution system 12. To generate the usage report using the communication device 83, the user interacts with a specialized application installed on the communication device 83 configured to operate the controller 10 in a remote manner. In response to a wireless command submitted by the user via the computing device 83, one of the processing unit 16 and the computing device 83 may be used to generate the usage report detailing information about at least one of water consumption and energy consumption.

FIG. 5 schematically illustrates the controller 10 and the fluid distribution system 12 configured for a shower 84. The valving manifold 68a shown in FIG. 5 is configured with eight of the solenoid valves 70. One of the inlets 72 is in fluid communication with the conduit 64 supplying cold water. One of the inlets 72 is in fluid communication with the conduit 64 supplying hot water. Six of the inlets 72 are in fluid communication with both of the conduits 64 to supplying a mixture of hot and cold water.

To operate the shower 84, the user touches a portion of the touch screen 14 designated as a “soft button” for controlling a flow of water to the shower 84 via the secondary plumbing arrangement 44. The soft button is an area of the display 26 which the user may recognize as performing a specific function. As a non-limiting example, the soft button for controlling the flow of water to the shower 84 may be designated by a power symbol. It is understood that the controller 10 may enter a “sleep mode” after a pre-designated amount of time after being placed in an off position by the user. In the sleep mode, the display 26 may be turned off. The user may “awake” the controller 10 by touching any portion of the touch screen 14, so that the soft buttons which are normally displayed become visible.

Upon recognition by the processing unit 16 that the user has touched the soft button for controlling the flow of water, the processing unit 16, through the output interface 18 and the system controller 48 opens at least one of the solenoid valves 70 of the valving manifold 68a. The processing unit 16 may select the at least one of the solenoid valves 70 based on a most recently used temperature setting or the processing unit 16 may select a default arrangement of the at least one of the solenoid valves 70. Upon the opening of the at least one of the solenoid valves 70, water flows to the shower 84 through the secondary plumbing arrangement 44.

The sensor 36 is typically disposed on a portion of the secondary plumbing arrangement 44 near the shower 84. In response to the processing unit 16 placing at least one of the solenoid valves 70 in the open position, the processing unit 16 also receives a signal from the sensor 36. In response to a change in the temperature of water flowing through the secondary plumbing arrangement 44, the signal sent by the sensor 36 is modified to reflect the change in temperature. Upon receipt of the signal by the processing unit 16 via the output interface 18, the processing unit 16 converts the signal into a temperature value, which is output to the display 26, for observation by the user. FIG. 5 illustrates the display 26 of the controller 10 displaying an exemplary temperature value. It is understood that the processing unit 16 may be configured to respond in a particular manner to the signal sent by the sensor 36, such as by closing the at least one solenoid valve 70 in response to the temperature value being above a predetermined value, for example.

After the user has touched the soft button for controlling the flow of water, the user may adjust a temperature of the flow of water to the shower 84. The user may adjust the temperature in one of two manners.

First, the user may adjust the temperature of the flow of water to the shower 84 incrementally by pressing one of a pair of soft buttons to raise or lower the temperature of the flow of water. As a non-limiting example, the soft buttons for adjusting the temperature of the flow of water may be designated by a plus symbol and a minus symbol. In response to a selection of a desired temperature, the processing unit 16 outputs the desired temperature to the display 26, for observation by the user.

The processing unit 16 then selects a solenoid valve profile based the selection of the desired temperature. The storage device 38 includes a plurality of solenoid valve profiles stored thereon, each of the solenoid valve profiles corresponding to a temperature that may be selected by the user. It is understood that the processing unit 16 may also employ an algorithm to determine which solenoid valves 70 to open instead of selecting a solenoid valve profile. The solenoid valves 70 are opened in response to a signal received from the system controller 48, in response to signals received from the processing unit 16 sent via the output interface 18.

Secondly, the user may adjust the temperature of the flow of water to the shower 84 by pressing a soft button corresponding to a temperature profile stored on the storage device 38. As a non-limiting example, the soft buttons corresponding to a temperature profile may be designated by text reading “User 1”, “User 2”, and “User 3”. FIG. 5 illustrates the display 26 of the controller 10 displaying three soft buttons corresponding to temperature profiles; however, it is understood that the controller 10 may be configured to display any number of soft buttons corresponding to temperature profiles. In response to a selection of one of the temperature profiles, the processing unit 16 outputs a temperature associated with the temperature profile to the display 26, for observation by the user.

The processing unit 16 then selects a solenoid valve profile based on one of the temperature profiles. The storage device 38 includes a plurality of solenoid valve profiles stored thereon, each of the solenoid valve profiles corresponding to a temperature that may be selected by the user by selecting one of the temperature profiles. It is understood that the processing unit 16 may also employ an algorithm to determine which solenoid valves 70 to open instead of selecting a solenoid valve profile. The solenoid valves 70 are opened in response to a signal received from the system controller 48, in response to signals received from the processing unit 16 sent via the output interface 18.

When the user desires to adjust the temperature of the flow of water to the shower 84 after initially selecting a temperature, the user may adjust the temperature of the flow of water to the shower 84 in either of the above described options.

When the user desires to stop operation of the shower 84, the user touches the soft button for controlling a flow of water to the shower 84 via the secondary plumbing arrangement 44. Upon recognition by the processing unit 16 that the user has touched the soft button for controlling the flow of water, the processing unit 16, through the output interface 18 and the system controller 48 closes one or all of the solenoid valves 70 that are in the open position.

As mentioned hereinabove, the controller 10 and the fluid distribution system 12 may also be configured to be controlled using the wireless communication device 83 over a local area wireless network. To operate the shower 84 using the communication device 83, the user interacts with the specialized application installed on the communication device 83 configured to operate the controller 10 in a remote manner. Upon recognition by the processing unit 16 that the user has instructed the controller 10 to operate in a remote manner using the communication device 83, the processing unit 16, through the output interface 18 and the system controller 48, opens at least one of the solenoid valves 70 of the valving manifold 68a to operate the shower 84 in any of the manners described hereinabove.

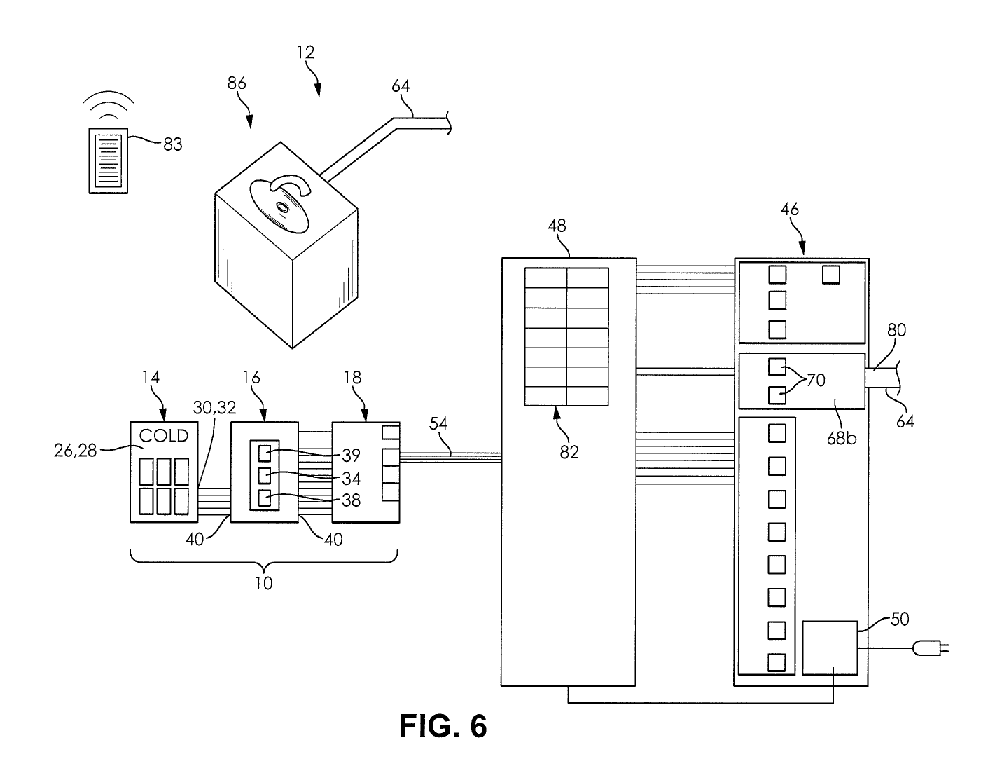

FIG. 6 schematically illustrates the controller 10 and the fluid distribution system 12 configured for a lavatory sink 86. The valving manifold 68b shown in FIG. 6 is configured with two of the solenoid valves 70. One of the inlets 72 is in fluid communication with the conduit 64 supplying cold water. The remaining inlet 72 is in fluid communication with the conduit 64 supplying hot water.

To operate the lavatory sink 86, the user touches a portion of the touch screen 14 designated as a soft button for controlling a flow of water to the lavatory sink 86 via the secondary plumbing arrangement 44. As a non-limiting example, the soft button for controlling the flow of water to the lavatory sink 86 may be designated by a power symbol.

Upon recognition by the processing unit 16 that the user has touched the soft button for controlling the flow of water, the processing unit 16, through the output interface 18 and the system controller 48 opens at least one of the solenoid valves 70 of the valving manifold 68b. The processing unit 16 may select one or both of a pair of the solenoid valves 70 based on a most recently used temperature setting or the processing unit 16 may select a default arrangement of the solenoid valves 70. Upon the opening of one or both of the solenoid valves 70, water flows to the lavatory sink 86 through the secondary plumbing arrangement 44.

In response to the processing unit 16 placing one or both of the solenoid valves 70 in the open position, the processing unit 16 also displays a temperature indication. In response to a selection by the processing unit 16, the processing unit selects the temperature indication corresponding to the solenoid valves 70 placed in the open position. The temperature indication is output to the display 26, for observation by the user. FIG. 6 illustrates the display 26 of the controller 10 displaying an exemplary temperature indication. As non-limiting examples, the temperature indication may be “HOT”, “COLD”, or “WARM”.

After the user has touched the soft button for controlling the flow of water, the user may select a temperature of the flow of water to the shower 84. The user may select the temperature from three options, which appear as soft buttons on the display 26 of the controller 10.

First, the user may select the temperature of the flow of water to the lavatory sink 86 by pressing a “HOT” soft button. In response to the selection of the “HOT” soft button, the processing unit 16 selects the solenoid valve 70 of the valving manifold 68b in fluid communication with the conduit 64 supplying hot water, and is opened in response to a signal received from the system controller 48, in response to signals received from the processing unit 16 sent via the output interface 18.

Secondly, the user may select the temperature of the flow of water to the lavatory sink 86 by pressing a “COLD” soft button. In response to the selection of the “COLD” soft button, the processing unit 16 selects the solenoid valve 70 of the valving manifold 68b in fluid communication with the conduit 64 supplying cold water, and is opened in response to a signal received from the system controller 48, in response to signals received from the processing unit 16 sent via the output interface 18.

Lastly, the user may select the temperature of the flow of water to the lavatory sink 86 by pressing a “WARM” soft button. In response to the selection of the “WARM” soft button, the processing unit 16 selects the solenoid valves 70 of the valving manifold 68b in fluid communication with both the conduits 64 supplying cold water and the conduit supplying hot water. The solenoid valves 70 are opened in response to a signal received from the system controller 48, in response to signals received from the processing unit 16 sent via the output interface 18.

When the user desires to change the selected temperature of the flow of water to the lavatory sink 86 after initially selecting a temperature, the user may adjust the temperature of the flow of water to the lavatory sink 86 by selecting another soft button.

When the user desires to stop operation of the lavatory sink 86, the user touches the soft button for controlling a flow of water to the lavatory sink 86 via the secondary plumbing arrangement 44. Upon recognition by the processing unit 16 that the user has touched the soft button for controlling the flow of water, the processing unit 16, through the output interface 18 and the system controller 48 closes one or both of the solenoid valves 70 that are in the open position.

As mentioned hereinabove, the controller 10 and the fluid distribution system 12 may also be configured to be controlled using the wireless communication device 83 over a local area wireless network. To operate the lavatory sink 86 using the communication device 83, the user interacts with a specialized application installed on the communication device 83 configured to operate the controller 10 in a remote manner. Upon recognition by the processing unit 16 that the user has instructed the controller 10 to operate in a remote manner using the communication device 83, the processing unit 16, through the output interface 18 and the system controller 48, opens at least one of the solenoid valves 70 of the valving manifold 68a to operate the lavatory sink 86 in any of the manners described hereinabove.

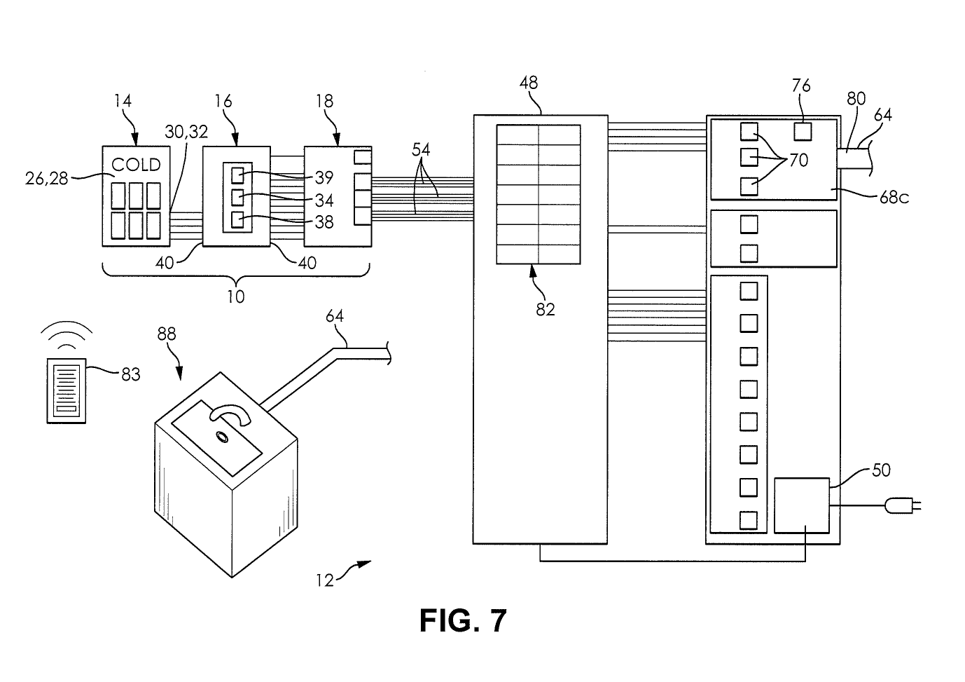

FIG. 7 schematically illustrates the controller 10 and the fluid distribution system 12 configured for a kitchen sink 88. The valving manifold 68c shown in FIG. 7 is configured with three of the solenoid valves 70 and one restricting solenoid valve 76. One of the inlets 72 is in fluid communication with the conduit 64 supplying cold water. One of the inlets 72 is in fluid communication with the conduit 64 supplying hot water. The last of the inlets 72 is in fluid communication with both of the conduits 64 to supplying a mixture of hot and cold water.

To operate the kitchen sink 88, the user touches a portion of the touch screen 14 designated as a soft button for controlling a flow of water to the kitchen sink 88 via the secondary plumbing arrangement 44. As a non-limiting example, the soft button for controlling the flow of water to the kitchen sink 88 may be designated by a power symbol.

Upon recognition by the processing unit 16 that the user has touched the soft button for controlling the flow of water, the processing unit 16, through the output interface 18 and the system controller 48 opens at least one of the solenoid valves 70 of the valving manifold 68c. The processing unit 16 may select one of the solenoid valves 70 and the restricting solenoid valve 76 based on a most recently used temperature and flow setting or the processing unit 16 may select a default arrangement of the solenoid valves 70 and the restricting solenoid valve 76. Upon the opening of one the solenoid valves 70 or one the solenoid valves 70 and the restricting solenoid valve 76, water flows to the kitchen sink 88 through the secondary plumbing arrangement 44.

In response to the processing unit 16 placing one of the solenoid valves 70 in the open position, the processing unit 16 also displays a temperature indication. In response to a selection by the processing unit 16, the processing unit selects the temperature indication corresponding to the solenoid valves 70 placed in the open position. The temperature indication is output to the display 26, for observation by the user. FIG. 7 illustrates the display 26 of the controller 10 displaying an exemplary temperature indication. As non-limiting examples, the temperature indication may be “HOT”, “COLD”, or “WARM”.

After the user has touched the soft button for controlling the flow of water, the user may select a temperature of the flow of water to the kitchen sink 88. The user may select the temperature from three options.

First, the user may select the temperature of the flow of water to the kitchen sink 88 by pressing the “HOT” soft button. In response to the selection of the “HOT” soft button, the processing unit 16 selects the solenoid valve 70 of the valving manifold 68c in fluid communication with the conduit 64 supplying hot water, and is opened in response to a signal received from the system controller 48, in response to signals received from the processing unit 16 sent via the output interface 18.

Secondly, the user may select the temperature of the flow of water to the kitchen sink 88 by pressing the “COLD” soft button. In response to the selection of the “COLD” soft button, the processing unit 16 selects the solenoid valve 70 of the valving manifold 68c in fluid communication with the conduit 64 supplying cold water, and is opened in response to a signal received from the system controller 48, in response to signals received from the processing unit 16 sent via the output interface 18.

Lastly, the user may select the temperature of the flow of water to the kitchen sink 88 by pressing the “WARM” soft button. In response to the selection of the “WARM” soft button, the processing unit 16 selects the solenoid valve 70 of the valving manifold 68c in fluid communication with both the conduits 64 supplying cold water and the conduit supplying hot water. The solenoid valve 70 is opened in response to a signal received from the system controller 48, in response to a signal received from the processing unit 16 sent via the output interface 18.

When the user desires to change the selected temperature of the flow of water to the kitchen sink 88 after initially selecting a temperature, the user may adjust the temperature of the flow of water to the kitchen sink 88 by selecting another soft button.

As mentioned hereinabove, the controller 10 and the fluid distribution system 12 may also be configured to be controlled using the wireless communication device 83 over a local area wireless network. To operate the kitchen sink 88 using the communication device 83, the user interacts with a specialized application installed on the communication device 83 configured to operate the controller 10 in a remote manner. Upon recognition by the processing unit 16 that the user has instructed the controller 10 to operate in a remote manner using the communication device 83, the processing unit 16, through the output interface 18 and the system controller 48, opens at least one of the solenoid valves 70 of the valving manifold 68a to operate the kitchen sink 88 in any of the manners described hereinabove.

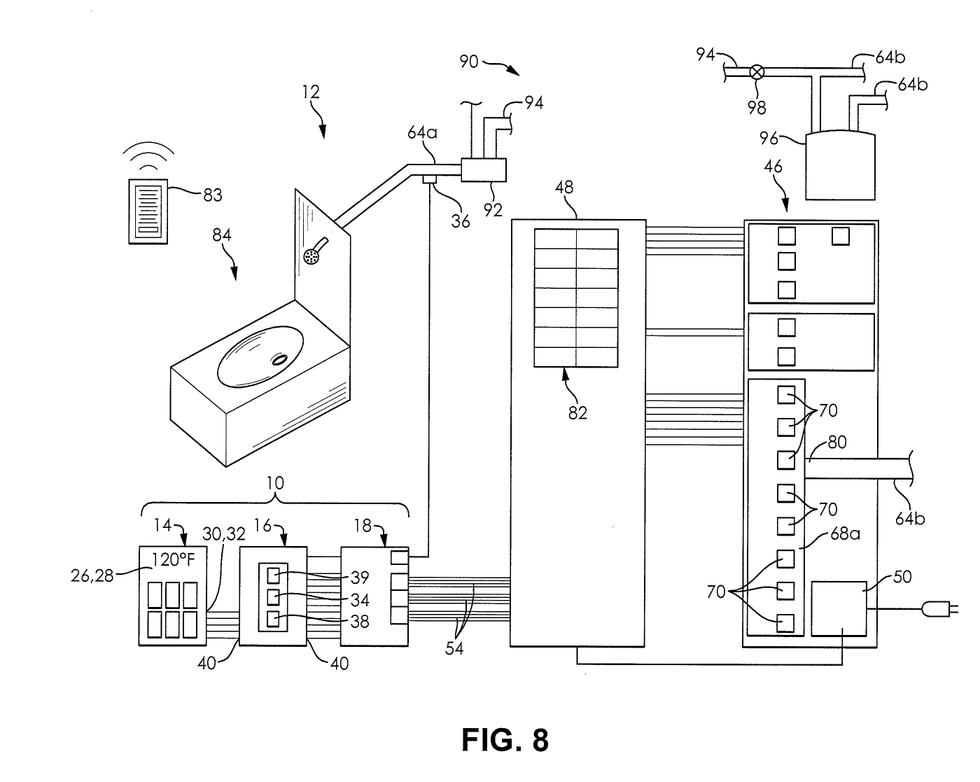

FIG. 8 schematically illustrates the controller 10 and the fluid distribution system 12 configured for the shower 84, as shown in FIG. 5. However, the fluid distribution system 12 shown in FIG. 8 further comprises a recirculation system 90. The recirculation system 90 includes a recirculation valve 92 and a recirculation line 94. The recirculation valve 92 is disposed on a conduit 64a in fluid communication with the shower 84. The recirculation valve 92 may be actuated to divert water from the conduit 64a through the recirculation line 94 to a conduit 64b, which supplies cold water to the fluid distribution system 12 or to a water heater 96 associated with the fluid distribution system 12. The recirculation line 94 is fitted with a check valve 98 which prevents water from flowing from the conduit 64b to the recirculation line 94. The recirculation valve 92 is in communication with the processing unit 16. The recirculation system 90 allows the fluid distribution system 12 to supply water to the shower 84 at a temperature selected by the user without the need to waste water and any energy therein as the conduit 64a may initially absorb a significant amount of heat from the water supplied thereto. The recirculation system 90 allows the fluid distribution system 12 to be operated in a recirculation mode to provide for increased conservation of energy and water.

To operate the fluid distribution system 12 in the recirculation mode, the user touches a portion of the touch screen 14 designated as a “soft button” designated for the recirculation mode. As a non-limiting example, a soft button associated placing the fluid distribution system 12 in the recirculation mode may be labeled as “ECO-START”.

Upon recognition by the processing unit 16 that the user has touched the soft button for placing the fluid distribution system 12 in the recirculation mode, the processing unit 16, through the output interface 18 and the system controller 48 opens at least one of the solenoid valves 70 of the valving manifold 68a and actuates the recirculation valve 92 to divert water from the conduit 64a through the recirculation line 94 to a conduit 64b. The processing unit 16 may select the at least one of the solenoid valves 70 based on a most recently used temperature setting, the processing unit 16 may select a default arrangement of the at least one of the solenoid valves 70, or the processing unit 16 may select the at least one of the solenoid valves 70 based on a temperature preference selected by the user.

As mentioned hereinabove, the sensor 36 is typically disposed on a portion of the secondary plumbing arrangement 44 near the shower 84. In response to the processing unit 16 placing the fluid distribution system 12 in the recirculation mode, the processing unit 16 also receives a signal from the sensor 36. In response to a change in the temperature of water flowing through the conduit 64a and the recirculation line 94, the signal sent by the sensor 36 is modified to reflect the change in temperature. Upon receipt of the signal by the processing unit 16 via the output interface 18, the processing unit 16 converts the signal into a temperature value, which is output to the display 26, for observation by the user. FIG. 8 illustrates the display 26 of the controller 10 displaying an exemplary temperature value. Once the processing unit 16 recognizes that the signal sent by the sensor 36 is equivalent to one of a most recently used temperature setting, at temperature associated with a default arrangement of the at least one of the solenoid valves 70, or a temperature preference selected by the user, the processing unit 16 closes any open solenoid valves 70 and closes the recirculation valve 92. Upon closure of any open solenoid valves 70 and the recirculation valve 92, the processing unit 16 may output an indication to the display 26, for observation by the user. As a non-limiting example, the indication output by the processing unit 16 may be “SHOWER READY”.

As mentioned hereinabove, the controller 10 and the fluid distribution system 12 may also be configured to be controlled using the wireless communication device 83 over a local area wireless network. To operate the shower 84 in the recirculation mode using the communication device 83, the user interacts with a specialized application installed on the communication device 83 configured to operate the controller 10 in a remote manner. Upon recognition by the processing unit 16 that the user has instructed the controller 10 to operate in a remote manner using the communication device 83, the processing unit 16, through the output interface 18 and the system controller 48, opens at least one of the solenoid valves 70 of the valving manifold 68a to operate the shower 84 in the recirculation mode.

The controller 10 may also be configured to operate the fluid distribution system 12 in a manner that conserves water. By actuating the restricting solenoid valve 76, the restricting solenoid valve 76 permits fluid to flow from the valving manifold 68c to the secondary plumbing arrangement 44 at flow rate less than a flow rate when the restricting solenoid valve 76 is placed in the open position. To operate the kitchen sink 88 in the manner that conserves water, the user touches a portion of the touch screen 14 designated as a soft button for controlling a position of the restricting solenoid valve 76. As a non-limiting example, a soft button associated with a position of the restricting solenoid valve 76 may be labeled as “ECO-FLOW”.

Upon recognition by the processing unit 16 that the user has touched the soft button for operating the fluid distribution system 12 in a manner that conserves water, the processing unit 16, through the output interface 18 and the system controller 48 places the restricting solenoid valve 76 in the restricted position. Upon placing the restricting solenoid valve 76 in the restricted position, water flows to the kitchen sink 88 through the secondary plumbing arrangement 44 in a manner that conserves water.

When the user desires to stop operation of the kitchen sink 88, the user touches the soft button for controlling a flow of water to the kitchen sink 88 via the secondary plumbing arrangement 44. Upon recognition by the processing unit 16 that the user has touched the soft button for controlling the flow of water, the processing unit 16, through the output interface 18 and the system controller 48 closes the solenoid valve 70 that is in the open position.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A controller for use with a fluid distribution system, the controller comprising:
a touch screen;
a processing unit in communication with the touch screen; and
an output interface in communication with the processing unit and the fluid distribution system, wherein in response to a touch input from a user, the processing unit accesses at least one valve profile and adjusts a state of operation of the fluid distribution system through the output interface.

2. The controller according to claim 1, wherein the controller is in communication with a sensor to provide the processing unit with information regarding a state of operation of the fluid distribution system.

3. The controller according to claim 2, wherein the temperature sensor is disposed on a portion of the fluid distribution system.

4. The controller according to claim 3, wherein in response to information received from the sensor, the processing unit displays a temperature value on the touch screen.

5. The controller according to claim 1, wherein the output interface includes specialized circuitry which facilitates conversion of a microcontroller level output signal from the processing unit to an output level compatible with the fluid distribution system.

6. The controller according to claim 1, wherein the processing unit executes a series of instructions in response to a data signal from a sensor via the output interface.

7. The controller according to claim 1, wherein the processing unit accesses information on a portion of the processing unit, changes information on the portion of the processing unit, adjusts a signal supplied to the output interface, and adjusts a signal supplied to the touch screen in response to a touch input from the user via the touch screen.

8. The controller according to claim 7, wherein the touch input from the user is a selection of a desired temperature and the processing unit selects a valve profile based on the selection of a desired temperature.

9. The controller according to claim 1, wherein the processing unit comprises at least one microcontroller including a storage device for information.

10. The controller according to claim 9, wherein the information includes at least one of a temperature profile, a series of instructions to be executed by the processing unit, or a series of instructions used to operate the at least a portion of the touch screen.

11. The controller according to claim 1, wherein the processing unit further comprises a communication module.

12. The controller according to claim 11, wherein the communication module allows the user to adjust a state of operation of the fluid distribution system using a computing device in a wireless manner.

13. The controller according to claim 12, wherein in response to a wireless command from the user via the computing device, one of the processing unit and the computing device generates a usage report regarding the operation of the fluid distribution system.

14. The controller according to claim 1, wherein the fluid distribution system further comprises a recirculation valve and a recirculation line.

15. The controller according to claim 14, wherein in response to a wireless command from the user via the computing device, the processing unit adjusts a state of operation of the fluid distribution system to place a portion of the fluid distribution system in a recirculation mode.

16. A fluid distribution system comprising:
a primary plumbing arrangement in fluid communication with a fluid source,
a valving arrangement in fluid communication with the primary plumbing arrangement;
a secondary plumbing arrangement in fluid communication with the valving arrangement;
a system controller in communication with the valving arrangement; and
a controller in communication with the system controller, the controller comprising a touch screen, a processing unit in communication with the touch screen, and an output interface in communication with the processing unit and the fluid distribution system, wherein in response to a touch input from a user, the processing unit accesses at least one valve profile and adjusts the valving arrangement of the fluid distribution system through the output interface and the system controller.

17. A method of operating a fluid distribution system comprising the steps of:
providing the fluid distribution system in fluid communication with a fluid source, the fluid distribution system including a valving arrangement;
providing a controller in communication with the fluid distribution system, the controller comprising a touch screen, a processing unit in communication with the touch screen, and an output interface in communication with the processing unit and the fluid distribution system;
providing a touch input from a user of the fluid distribution system to the processing unit via the touch screen;
accessing at least one valve profile using the processing unit in response to the touch input from a user; and
adjusting the valving arrangement of the fluid distribution system using the processing unit through the output interface.

18. The method according to claim 17, wherein the step of adjusting a state of operation of the fluid distribution system is performed by the processing unit, the processing unit employing an algorithm to determine how to adjust a state of operation of the fluid distribution system.

19. The method according to claim 17, further comprising the step of displaying an exemplary temperature indication on the touch screen in response to the processing unit adjusting a state of operation of the fluid distribution system.

20. The method according to claim 17, wherein the step of adjusting the valving arrangement of the fluid distribution system is performed to restrict a flow rate through the fluid distribution system in response to a touch input from the user.
